(19) United States
(12) Patent Application Publication
(10) Pub. No.: US 2011/0214256 A1
(43) Pub. Date: Sep. 8, 2011

(54) Handle Attachment

(76) Inventor: Kathleen Stone, Canyon Country, CA (US)

(21) Appl. No.: 12/715,386

(22) Filed: Mar. 2, 2010

(51) Int. Cl. B25G 1/10; B25G 1/00; A44B 18/00

(52) U.S. Cl. 16/430; 16/110.1

(57) ABSTRACT

The present invention relates to handles and handle attachments, including a handle attachment comprising a handle end, attached to a strap of nylon, leather, polyprolene or any other suitable material with Velcro hook on one half and loop fastening on the other end. The handle attachment may be secured to an item to be carried by feeding the lower strap around the item or items then through a ring, attaching the Velcro hook end to the loop fastening.

### FIELD OF THE INVENTION

The present invention relates to handle attachments and, in particular, to a handle attachment for attaching to an item to provide additional length and comfort and/or to carry multiple items together or pull items with one handle.

### BACKGROUND

Luggage, briefcases, and other items are often provided with a handle to allow the user to grip the item to pull or carry it. However, the existing handles provided on luggage, suitcases, purses, and other items may be located at inconvenient positions or angles, or may be uncomfortable when gripped firmly. The user may have to bend his or her arm or body at an awkward or uncomfortable angle in order to reach the existing handle. Additionally, it may be difficult for the user to grip multiple items at the same time, such as several pieces of luggage, or several different bags, purses, or other items. When each item has its own separate handle, it may be difficult for a person to carry two or more items at the same time.

Thus, there is a need for a handle attachment device that can improve the comfort and reach of existing handles, and/or that can allow a user to grip multiple items simultaneously.

### SUMMARY

The present invention relates to handle attachments that can be secured to an item or items to be carried with greater ease and comfort. The invention, the handle attachment comprises a handle end comprising an opening having sufficient size to receive a hand; attached to a strap of nylon, leather, polyprolene or any other suitable material. The ends of the strap are then attached together creating a loop. An additional strap of nylon, leather, polyprolene or any other suitable material with Velcro hook attached to one third, Velcro loop attached to two thirds and a rectangular loop attached to the other end is attached to the handle strap. The handle attachment may be secured to an item to be carried by feeding the lower strap around the item or items then through a rectangular ring, cinching the Velcro hook end to the loop fastening.

In still other embodiments, the handle attachment may be formed of vinyl, rubber, silicone, plastics, such as thermoplastic, polyurethane and urethane, or any other suitable material. The handle portion may be contoured to fit to a human hand, to provide comfortable and efficient gripping. The size and length of the Velcro hook and loop strap may be varied according to the desired purpose or use.

Other features and variations of the handle attachment summarized above are also contemplated and will be more fully understood when considered with respect to the following disclosure.

### BRIEF DESCRIPTION OF THE DRAWINGS

These and other features and advantages of the present invention will become appreciated as the same become better understood with reference to the specification, claims and appended drawings wherein:

FIG. 1 is a view of a handle attachment in an embodiment of the present invention;

FIG. 2 is a view of the handle attachment of FIG. 1, with the Velcro hook and loop strap threading through the receiving loop of the strap;

FIG. 3 is a view of the handle attachment of FIG. 1, with the Velcro hook and loop strap closed showing the loop created;

### DETAILED DESCRIPTION

The detailed description set forth below in connection with the appended drawings is intended as a description of the presently preferred embodiments of a handle attachment provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

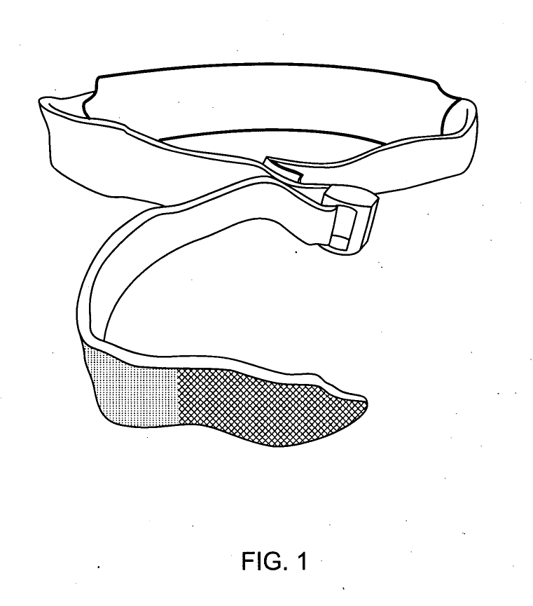

With reference to FIG. 1, a handle attachment made of a rubber handle, with a strap through the middle which comes down on both sides and attach to one another at the bottom, creating a hand opening, then a strap consisting of Velcro hook and loop on one end and a plastic loop on the other end is secured parallel to the handle strap. In this way, the handle attachment may be secured to the existing handle or item(s) without requiring any bulky or complicated attachment mechanisms such as clips, fasteners, belts, knots, clasps, or other similar means for attachment.

The hand opening receives the user's hand so that the user can grip the handle attachment to lift, carry, or pull it. The hand opening is preferably large enough in size that a user can comfortably place four fingers through the opening to grip the handle end. The size of the hand opening may vary according to different embodiments of the invention. For example, a handle attachment sized for use by a child may include a hand opening that is smaller than a hand opening sized for use by an adult. In one embodiment, the hand opening may be sized for four fingers, while in other embodiments it may be sized for more or less than four fingers. For example, in one embodiment, the hand opening may be sized for more than five fingers, as it may be desired to use both hands to pull or grip an item with the handle attachment.

In the embodiment shown in FIG. 1, the hand opening is sized for four fingers accommodate different hand and finger shapes and sizes, and may include grooves arranged in any desirable manner for comfort and convenience for the user. In one embodiment, finger grooves may be distinct and separated finger holes formed in the handle end, instead of open finger grooves. In such an embodiment, the hand opening is not necessary, as the user may place the fingers through the finger holes instead of placing the hand through the hand opening. When the hand opening is present, the finger grooves and/or holes are optional.

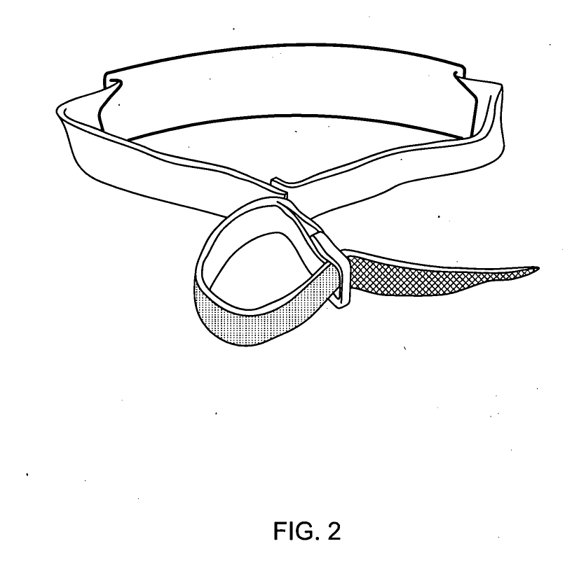

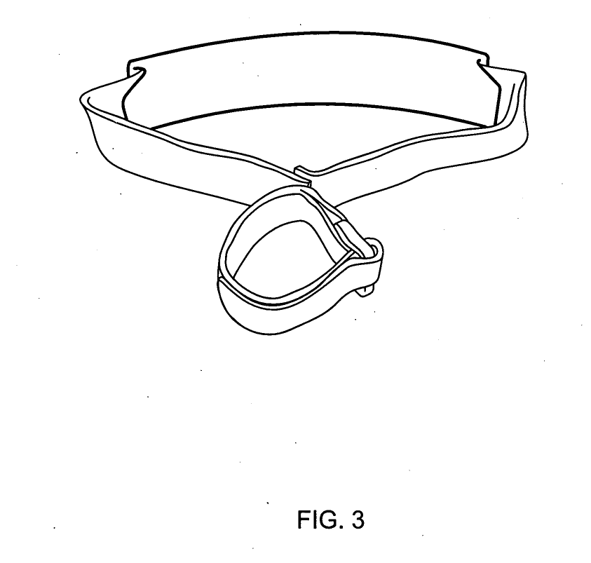

In the embodiment shown in FIG. 2 and FIG. 3, in use, the handle is attached around an existing handle or item(s), such as a luggage handle. The Velcro hook and loop strap end is fed through the loop opening and attached to itself. This procedure secures the handle attachment to the existing handle or item(s). The user can then place his or her hand in the hand opening and pull the luggage handle or other item(s) by pulling the handle attachment. The handle attachment can be used to replace or extend an existing handle, or to group together multiple handles or items and carry them together.

The handle opening and Velcro hook and loop strap do not have to be increased to such a size where they might become caught around something or someone and possibly pose a safety risk.

With reference to FIG. 2 and FIG. 3, a handle attachment in an embodiment of the present invention creating a loop to fold around an existing handle. The existing handle could be a luggage handle, a ladder rung, or any other item(s) that the user desires to grip. The Velcro hook and loop strap portion of the handle attachment is placed next to the existing handle and folded around it, then the Velcro hook and loop side of the strap is fed through the loop at the other end of the strap and attached to itself.

To secure the handle attachment to the existing handle, the Velcro hook and loop strap is wrapped around the existing handle then passed through the loop on the other end of the strap and attached to itself. The user can then place his or her hand through the hand opening and grip the handle end.

To release the handle attachment from the existing handle, the process is conducted in reverse. The Velcro hook and loop is released from itself and fed back through the loop. The handle attachment can then be stored and used again when needed.

Although limited embodiments of the handle attachment have been specifically described and illustrated herein, many modifications and variations will be apparent to those skilled in the art. For example, the handle attachment may be shaped into any desired contour and may be made in many different sizes. The length of the Velcro hook and loop portion of the strap may vary in length. Accordingly, it is to be understood that the handle attachment constructed according to principles of this invention may be embodied other than as specifically described herein. The invention is also defined in the following claims.

What is claimed is:

1. A handle attachment comprising:
a handle end comprising a handle and strap; and
a strap configured with Velcro hook and loop and a ring attached to the end to cinch the strap around and complete a loop;

2. The handle attachment of claim 1, wherein the handle may include finger grooves.

3. The handle attachment of claim 1, wherein the handle attachment is formed of a handle, strap, Velcro and ring.

4. The handle attachment of claim 1, wherein the handle comprises an opening for receiving the hand.

5. A handle attachment for attaching to an item comprising:
a handle end comprising a handle;
a receiving end comprising of a strap, Velcro hook and loop, and ring.

6. The handle attachment, wherein the Velcro hook and loop segments are configured to cinch around the ring at the end of the strap.

7. The strap attachment, wherein the handle comprises an opening for receiving the hand.

8. A handle attachment comprising:
a handle end comprising an opening having sufficient size to receive a hand;
a receiving end comprising of a strap, Velcro hook and loop, and a ring to be used for cinching the strap.

9. The handle attachment, wherein the opening of the handle end may be contoured to a shape of a hand.
